(19) United States
(12) Patent Application Publication
(10) Pub. No.: US 2024/0366985 A1
(43) Pub. Date: Nov. 7, 2024

(54) AEROSOL FIRE EXTINGUISHING AGENT COMPOSITION

(71) Applicant: YAMATO PROTEC CORPORATION, Tokyo (JP)

(72) Inventors: Shogo Tomiyama, Inashiki-gun (JP); Akimasa Tsutsumi, Inashiki-gun (JP)

(73) Assignee: YAMATO PROTEC CORPORATION, Tokyo (JP)

(21) Appl. No.: 18/565,631

(22) PCT Filed: Jun. 2, 2022
(86) PCT No.: PCT/JP2022/022499

§ 371 Date: Nov. 30, 2023

(30) Foreign Application Priority Data
Jun. 9, 2021 (JP) 2021-096440

(51) Int. Cl. A62D 1/06

(52) U.S. Cl. CPC A62D 1/06

(57) ABSTRACT

Provided is an aerosol fire extinguishing agent composition which can be used as a fire extinguishing agent when a fire occurs. This aerosol fire extinguishing composition comprises: (A) an aerosol generating agent component comprising at least one from among ammonia, an alkali metal, an alkali earth metal, and a halogen; and (B) an oxidizing agent component comprising at least one from among a nitrate, a chlorate, a perchlorate, a peroxide, and a metal oxide.

### TECHNICAL FIELD

The present invention relates to an aerosol fire extinguishing agent composition which can suppress and extinguish a fire by generating an aerosol through combustion and an aerosol generating automatic fire extinguishing device using the same.

### BACKGROUND ART

Common fire extinguishers, fire extinguishing devices and the like are filled with a fire extinguishing agent in the powdery state. Basically, such fire extinguishers and extinguishing devices have a function that, when diffusing a fire extinguishing agent in a fine powder state toward the flame during operation, radicals such as potassium radicals are generated instantly, and the generated radicals catch the hydrogen radical, oxygen radical, hydroxyl radical and the like which promote the combustion reaction to extinguish the fire.

Since these fire extinguishers and fire extinguishing devices using powder type fire extinguishing agents diffuse the powder as it is, they need to be a large and bulky container, and since the powder is ejected instantly, the container should be a high-pressure resistant container, which becomes heavy.

Here, for example, in Patent Document 1 (Russian Patent No. RU2357778 C2), in order to realize a more compact extinguishing device, by using a pyrotechnic composition composed of dicyandiamide as a fuel component and potassium nitrate as an oxidizing component, it is possible to generate an aerosol containing a potassium radical derived from the oxidizing agent.

### PRIOR ART DOCUMENT

### Patent Document

Patent Document 1: Russian Patent No. RU2357778 02

### SUMMARY OF THE INVENTION

### Problem to be Solved by the Invention

The present invention provides an aerosol fire extinguishing agent composition which can make a fire extinguisher, a fire extinguishing device or the like more compact and lightweight in comparison with the powder-type fire extinguishing agent, when using as the fire extinguishing agent for the fire extinguisher, the fire extinguishing device or the like, and an aerosol generating automatic extinguishing device using the aerosol fire extinguishing agent composition.

### Means to Solve the Above Problem

In order to solve the above object, the present invention provides an aerosol fire extinguishing agent composition containing:
(A) an aerosol generating agent component containing at least one of ammonia, an alkali metal, an alkaline earth metal, and a halogen; and
(B) an oxidizing agent component containing at least one of a nitrate, a chlorate, a perchlorate, a peroxide, and a metal oxide.

In the aerosol fire extinguishing agent composition of the present invention, it is preferable that the aerosol generating agent component (A) is at least one of an ammonium compound, a fluoride, a chloride, a bromide, an iodide, a lithium compound, a sodium compound, a cesium compound, a magnesium compound, and a calcium compound.

In the aerosol fire extinguishing agent composition of the present invention, it is preferable that the oxidizing agent component (B) is at least one of ammonium nitrate, lithium nitrate, sodium nitrate, strontium nitrate, sodium chlorate, cesium chlorate, strontium chlorate, ammonium chlorate, magnesium chlorate, calcium chlorate, lithium perchlorate, sodium perchlorate, cesium perchlorate, magnesium perchlorate, strontium perchlorate, strontium peroxide, iron oxide, copper oxide, and molybdenum oxide.

Further, it is preferable that the aerosol fire extinguishing agent composition of the present invention has an apparent density of 1.0 g/cm³ or more.

Furthermore, the present invention provides an aerosol generating automatic fire extinguishing device containing the aforementioned aerosol fire extinguishing agent composition of the present invention.

### Effects of the Invention

The fire extinguishing agent composition and the aerosol generating automatic fire extinguishing device using the same do not diffuse the powder as it is, but can generate an aerosol having an extinguishing ability which is ignited and burned automatically by the heat due to the fire. Therefore, it is possible to make an extinguisher, an extinguishing device or the like more compact and lightweight in comparison with the case where the powder-type fire extinguishing agent is used.

### BRIEF DESCRIPTION OF THE DRAWINGS

FIG. 1 is a diagram for explaining a test method of a confirmation test of extinguishing test by using an aerosol fire extinguishing agent composition of the present invention (combustion space volume being 5 L).

FIG. 2 is another diagram for explaining the test method of the confirmation test of extinguishing test by using an aerosol fire extinguishing agent composition of the present invention (combustion space volume being 2000 L).

### MODE FOR CARRYING OUT THE INVENTION

Hereinafter, an aerosol fire extinguishing agent composition and an aerosol generating automatic fire extinguishing device using the same according to a typical embodiment of the present invention will be described in detail with reference to the table. However, the present invention is not limited to these, and various design changes are possible, and all embodiments that have the technical matters described in the claims are included in the present invention.

### <Aerosol Fire Extinguishing Agent Composition>

The aerosol fire extinguishing agent composition according to the present invention comprises (A) an aerosol generating agent component containing at least one of ammonia, an alkali metal, an alkaline earth metal, and a halogen; and (B) an oxidizing agent component containing at least one of a nitrate, a chlorate, a perchlorate, a peroxide, and a metal oxide.

The aerosol generating agent component (A) is a component for generating the aerosol by generating thermal energy through combustion together with the oxidizing agent component (B), in other word, a fuel, and contains at least one of ammonia, an alkali metal, an alkaline earth metal, and a halogen. That is, the aerosol generating agent component (A) is one or more types containing at least one molecule or element of ammonia, an alkali metal, an alkaline earth metal, and a halogen.

Further, it is preferable that the aerosol generating agent component (A) is at least one of an ammonium compound, a fluoride, a chloride, a bromide, an iodide, a lithium compound, a sodium compound, a cesium compound, a magnesium compound, and a calcium compound.

Next, the oxidizing agent component (B) is a component for generating thermal energy through combustion together with the aerosol generating agent component (A), and contains at least one of a nitrate, a chlorate, a perchlorate, a peroxide, and a metal oxide.

Among them, it is preferable that the oxidizing agent component (B) contains at least one of ammonium nitrate, lithium nitrate, sodium nitrate, strontium nitrate, sodium chlorate, cesium chlorate, strontium chlorate, ammonium chlorate, magnesium chlorate, calcium chlorate, lithium perchlorate, sodium perchlorate, cesium perchlorate, magnesium perchlorate, strontium perchlorate, strontium peroxide, iron oxide, copper oxide, and molybdenum oxide.

When the total amount of the aerosol generating agent component (A) and the oxidizing agent component (B) is 100% by mass, the aerosol generating agent component (A) is 20 to 50% by mass, preferably 25 to 40% by mass, more preferably 25 to 35% by mass, and the oxidizing agent component (B) is 80 to 50% by mass, preferably 75 to 60% by mass, more preferably 75 to 65% by mass.

The aerosol fire extinguishing agent composition according to the present invention may contain, in addition to the aerosol generating agent component (A) and the oxidizing agent component (B), additives which are necessary for molding, such as a binder, a plasticizer, and a release agent.

Furthermore, it is preferable that the aerosol fire extinguishing agent composition according to the present invention preferably contains a molding aid component (C) in addition to the aerosol generating agent component (A) and the oxidizing agent component (B). The molding aid component (C) is a binder, a plasticizer, a lubricant, or the like that is necessary for molding the aerosol generating agent component (A) and the oxidizing agent component (B), and may include, for example, any one of CMC-Na (carboxymethyl cellulose sodium salt), ethyl cellulose, PVA (polyvinyl alcohol), PVB (polyvinyl butyrate), PVP (polyvinylpyrrolidone), starch, guar gum, carrageenan, gum arabic, natural rubber, synthetic rubber, silica, alumina, mica, silica alumina, carbon graphite, stearate, and whisker, and preferable is CMC-Na.

The content ratio of the molding aid component (C) is 0.1 to 100 parts by mass with respect to 100 parts by mass of the total amount of the aerosol generating agent component (A) and the oxidizing agent component (B), preferably 0.5 to 50 parts by mass.

The aerosol fire extinguishing agent composition of the present invention has a thermal decomposition starting temperature in the range of over 90° C. to 260° C., preferably over 150° C. to 260° C. The thermal decomposition starting temperature can be met by combining the aerosol generating agent component (A), the oxidizing agent component (B), and the molding aid component (C) in the aforementioned ratios.

According to the composition of the present invention, when satisfying the aforementioned range of the thermal decomposition temperature, by receiving the heat during the fire without using an ignition device, or the like it is possible to automatically ignite and burn the aerosol generating agent component (A) and an oxidizing agent component (B) to generate the aerosol derived from the aerosol generating agent component (A) and then extinguish the fire.

Since an ignition temperature of ordinary wood as a flammable material in a room is 260° C., when setting the thermal decomposition temperature within the condition where the heat sensor would not be activated under the general operating temperature of the heat sensor of an automatic fire alarm system which is installed in a place handling fire, that is, 90° C. or low, it is possible to instantly extinguish the fire and prevent erroneous operation of the heat sensor. In particular, since the maximum setting temperature of the heat sensor is 150° C., high versatility can be obtained by setting the lower limit of the thermal decomposition starting temperature to over 150° C.

The manner of the composition of the present invention is not particularly limited, and may be a powder or a molded article of desired shape. The molded article may be in the form of granules, pellets of desired shape (columnar shape, etc.), tablets, spherical shapes, circular plates and the like. In the case of the molded article, an apparent density thereof is preferably 1.0 g/cm³ or more.

### <Aerosol Generating Automatic Extinguishing Device>

The automatic extinguishing device of the present invention may be either in the form of a device which does not have an ignition means for igniting the aerosol generating agent, or in the form of a device which has a known initiation means such as an initiator or a detonator for igniting.

In the automatic extinguishing device according to the present invention, the automatic extinguishing device without the ignition means can be made in the form where the aerosol fire extinguishing agent composition of the present invention is contained in a combustible or incombustible container.

As the automatic extinguishing device, the device where the fire extinguishing agent composition of the present invention is contained in a combustible container can be used, for example, by throwing the whole of the aforementioned container into a flame.

On the other hand, when the automatic extinguishing device of the present invention is the device where the aerosol fire extinguishing agent composition of the present invention is contained in an incombustible container can be used, for example, by sprinkling the composition through the opening of the container to the igniting cooked contents (igniting contents in a pan, etc.).

Further, the automatic extinguishing device of the present invention can be used in a manner where the fire extinguishing agent composition of the present invention is contained in a container made of a material having good thermal conductivity (aluminum, copper, etc.), and further, the container may have a fin structure for increasing the surface area in order to enhance heat collection effect. This automatic extinguishing device can be used, in order to deal with when a fire occurs due to an unlikely ignition, for example, by placing near various batteries.

The automatic extinguishing device having the ignition means may be a device where a container where the aerosol fire extinguishing agent composition of the present invention as a fire extinguishing agent and the ignition means are installed is combined with the heat sensor for transmitting the fire occurrence to the ignition means to operate.

### EXAMPLE

### Examples 1 to 9 and Comparative Examples 1, 3 and 4

Component (A), Component (B) and Component (C) shown in Table 1 were thoroughly mixed in the blending ratios (as dry matter not containing water and solvent) shown in Table 1, and an ion exchanged water equivalent to 10 parts by mass was added to 100 parts by mass of the total amount of Component (A), Component (B) and Component (C) and mixed to a water-moist mixture.

The obtained water-moist mixture was dried in a constant temperature oven at 110° C.×16 hours to obtain a dried product having a water content of 1% by mass or less. The thus obtained dried product was pulverized in an agate mortar and sized to a particle diameter of 500 μm or less to obtain a pulverized product.

Next, 2.0 g of the pulverized product was filled in a predetermined metal mold (die) having an inner diameter of 9.6 mm, and a punch was inserted, and a hydraulic pump pressurized with a surface pressure of 220.5 MPa (2250 kg/cm²), every 5 seconds by exerting pressure from both sides to obtain the molded articles of the aerosol fire extinguishing agent composition (apparent density was 1.7 g/cm³ as shown in Table 1).

### Example 10

1.2 g of the pulverized product obtained in the same manner as in Example 1 was filled in a predetermined metal mold (die) having an inner diameter of 9.6 mm, and a punch was inserted, and a hydraulic pump pressurized with a surface pressure of 0.5 MPa (50 kg/cm²), every 5 seconds by exerting pressure from both sides to obtain the molded articles of the aerosol fire extinguishing agent composition (apparent density was 1.0 g/cm³ as shown in Table 1).

### Example 11

A pulverized product was prepared in the same manner as in Example 1. This pulverized product was used as the composition of the present invention.

### Example 12, 13

1.7 g of the pulverized product obtained in the same manner as in Example 1 was filled in a predetermined metal mold (die) having an inner diameter of 9.6 mm, and a punch was inserted, and a hydraulic pump pressurized with a surface pressure of 73.5 MPa (750 kg/cm²), every 5 seconds by exerting pressure from both sides to obtain the molded articles of the aerosol fire extinguishing agent composition (apparent density was 1.5 g/cm³ as shown in Table 1).

### Comparative Example 2

Only 2.0 g of Component (A) shown in Table 1 was filled in a predetermined metal mold (die) having an inner diameter of 9.6 mm, and a punch was inserted, and a hydraulic pump pressurized with a surface pressure of 220.5 MPa (2250 kg/cm²), every 6 seconds by exerting pressure from both sides to obtain the molded articles of the aerosol fire extinguishing agent composition (apparent density was 1.7 g/cm³ as shown in Table 1).

### [Extinguishing Test 1]

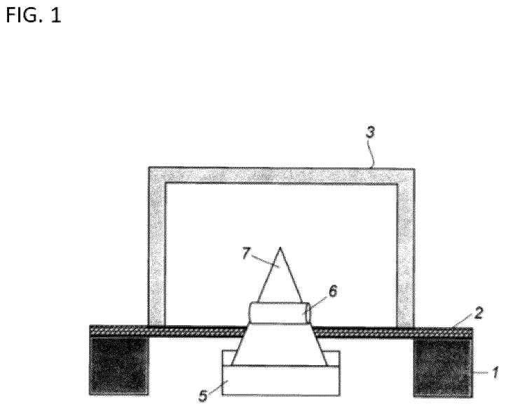

The test was carried out in the apparatus shown in FIG. 1. An iron wire mesh 2 was placed on a support desk 1, and the compositions (molded articles) 6 of Examples and Comparative Examples were placed in the center portion thereof. Example 10 (pulverized product) was placed in the center portion of the wire mesh 2 in a state of being put in an aluminum dish.

The wire mesh 2 was covered with a transparent container (5L) made of heat-resistant glass to seal the parts other than the part facing the metal mesh 2. A dish 5 containing 100 ml of n-heptane as an igniting agent was placed immediately under the composition 6 via the wire mesh 2.

In this manner, n-heptane was ignited to generate a flame 7, and the composition 6 was heated to generate an aerosol, and it was observed whether or not the flame 7 could extinguish. The results are shown in Table 1.

### [Extinguishing Test 2]

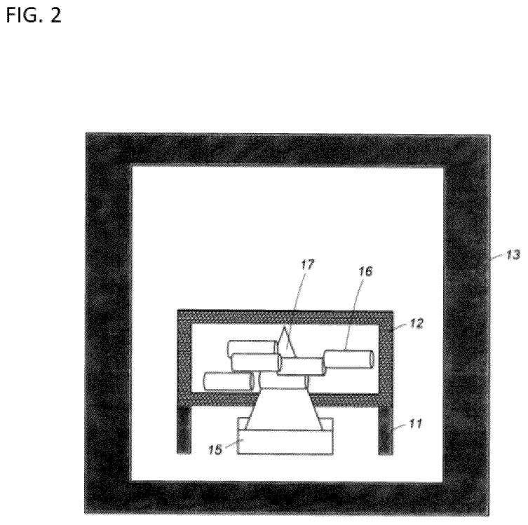

The test was carried out in the apparatus shown in FIG. 2. An iron wire mesh container 12 was placed on a support desk 11, and the compositions (molded articles) 16 of Examples and Comparative Examples were placed in the container.

A dish 15 containing 100 ml of n-heptane as an igniting agent was placed immediately under the composition 16 via the wire mesh 12. These support desk 11, the iron wire mesh container 12 and the dish 15 were placed a metal chamber 13 (2000 L) with an observing window.

In this manner, n-heptane was ignited to generate a flame 17, and the composition 16 was heated to generate an aerosol, and it was observed through the observing window whether or not the flame could extinguish. The results are shown in Table 1.

TABLE 1

| | Formulation | | | | | | | | |
|---|---|---|---|---|---|---|---|---|---|
| | Component (A) | | | | | | | | Component (B) |
| | trisodium | cesium | sodium | magnesium | calcium | potassium | lithium | potassium | strontium |
| | citrate | acetate | fluoride | phthalate | oxalate | iodide | bromide | phosphate | peroxide |
| Ex. 1 | 20.00 | — | — | — | — | — | — | — | 80.00 |
| Ex. 2 | 50.00 | — | — | — | — | — | — | — | — |
| Ex. 3 | 40.00 | — | — | — | — | — | — | — | — |
| Ex. 4 | — | 20.00 | — | — | — | — | — | — | 80.00 |
| Ex. 5 | — | — | 20.00 | — | — | — | — | — | — |
| Ex. 6 | — | — | — | 20.00 | — | — | — | — | 80.00 |
| Ex. 7 | — | — | — | — | 20.00 | — | — | — | 80.00 |
| Ex. 8 | — | — | — | — | — | 20.00 | — | — | — |
| Ex. 9 | — | — | — | — | — | — | 20.00 | — | 80.00 |
| Ex. 10 | 20.00 | — | — | — | — | — | — | — | 80.00 |
| Ex. 11 | 20.00 | — | — | — | — | — | — | — | 80.00 |
| Ex. 12 | 20.00 | — | — | — | — | — | — | — | 80.00 |
| Ex. 13 | 50.00 | — | — | — | — | — | — | — | — |
| Com. | — | — | — | — | — | — | — | — | 100.00 |
| E [symbol] | | | | | | | | | |
| Com. | 100.00 | — | — | — | — | — | — | — | — |
| E [symbol] | | | | | | | | | |
| Com. | 10.00 | — | — | — | — | — | — | — | 90.00 |
| E [symbol] | | | | | | | | | |
| Com. | — | — | — | — | — | — | — | 20.00 | 80.00 |
| E [symbol] | | | | | | | | | |

| | | | | | Extinguishing Test | | |
|---|---|---|---|---|---|---|---|
| | | | | | | Extin- | |
| | Formulation | | | | Amount | guished | |
| | Component (B) | | Component | Apparent | of used | space | |
| | ammonium | copper | (C) | density | composition | volume | Extin- |
| | chlorate | oxide | CMC-Na | (g/cm³) | (g/device) | (L) | guishment |
| Ex. 1 | — | — | 10.00 | 1.7 | 2.0/1 | 5 | Success |
| Ex. 2 | 50.00 | — | 0.50 | 1.7 | 2.0/1 | 5 | Success |
| Ex. 3 | 50.00 | 10.00 | 50.00 | 1.7 | 2.0/1 | 5 | Success |
| Ex. 4 | — | — | 10.00 | 1.7 | 2.0/1 | 5 | Success |
| Ex. 5 | 80.00 | — | 10.00 | 1.7 | 2.0/1 | 5 | Success |
| Ex. 6 | — | — | 10.00 | 1.7 | 2.0/1 | 5 | Success |
| Ex. 7 | — | — | 10.00 | 1.7 | 2.0/1 | 5 | Success |
| Ex. 8 | 80.00 | — | 10.00 | 1.7 | 2.0/1 | 5 | Success |
| Ex. 9 | 80.00 | — | 10.00 | 1.7 | 2.0/1 | 5 | Success |
| Ex. 10 | — | — | 10.00 | 1.0 | 2.0/1 | 5 | Success |
| Ex. 11 | — | — | 10.00 | — | 2.0 | 5 | Success |
| Ex. 12 | — | — | 10.00 | 1.5 | 2.0/50 | 2000 | Success |
| Ex. 13 | 50.00 | — | 0.50 | 1.5 | 2.0/50 | 2000 | Success |
| Com. | — | — | 10.00 | 1.7 | 2.0/1 | 5 | Failure |
| E [symbol] | | | | | | | |
| Com. | — | — | — | 1.7 | 2.0/1 | 5 | Failure |
| E [symbol] | | | | | | | |
| Com. | — | — | 10.00 | 1.7 | 2.0/1 | 5 | Failure |
| E [symbol] | | | | | | | |
| Com. | — | — | 10.00 | 1.7 | 2.0/1 | 5 | Failure |
| E [symbol] | | | | | | | |

[symbol]

indicates data missing or illegible when filed

As can be seen from the results shown in Table 1, in all cases where the aerosol fire extinguishing agent compositions according to Examples were used, fires could be extinguished instantly. On the other hand, when the aerosol fire extinguishing agent compositions according to the Comparative Examples were used, although the fire temporarily became smaller, the fire could not be extinguished.

The aerosol fire extinguishing agent composition of the present invention can be used as a fire extinguishing agent when a fire occurs.

### EXPLANATION OF SYMBOLS

1, 11: Support desk
2, 12: Wire mesh
3, 13: Container
5, 15: Igniting agent
6, 16: Fire extinguishing agent composition
7, 17: Flame

1. An aerosol generating fire extinguishing agent composition comprising:
(A) an aerosol generating agent component comprising at least one of ammonia, an alkali metal, an alkaline earth metal, and a halogen; and
(B) an oxidizing agent component comprising at least one of a nitrate, a chlorate, a perchlorate, a peroxide, and a metal oxide.

2. The aerosol generating fire extinguishing agent composition according to claim 1, wherein the aerosol generating agent component (A) is at least one of an ammonium compound, a fluoride, a chloride, a bromide, an iodide, a lithium compound, a sodium compound, a cesium compound, a magnesium compound, and a calcium compound.

3. The aerosol generating fire extinguishing agent composition according to claim 1, wherein the oxidizing agent component (B) is at least one of ammonium nitrate, lithium nitrate, sodium nitrate, strontium nitrate, sodium chlorate, cesium chlorate, strontium chlorate, ammonium chlorate, magnesium chlorate, calcium chlorate, lithium perchlorate, sodium perchlorate, cesium perchlorate, magnesium perchlorate, strontium perchlorate, strontium peroxide, iron oxide, copper oxide, and molybdenum oxide.

4. The aerosol generating fire extinguishing agent composition according to claim 1, wherein an apparent density is 1.0 g/cm³ or more.

5. An aerosol generating automatic fire extinguishing device comprising the aerosol generating fire extinguishing agent composition according to claim 1.
